(19) United States
(12) Patent Application Publication
(10) Pub. No.: US 2006/0280073 A1
(43) Pub. Date: Dec. 14, 2006

(54) Optical disc apparatus

(75) Inventor: Hiroshi Terai, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/438,288

(22) Filed: May 23, 2006

(30) Foreign Application Priority Data
May 24, 2005 (JP) 2005-151108

(51) Int. Cl. G11B 5/09

(52) U.S. Cl. 369/47.11

(57) ABSTRACT

When an apparatus is in a stop state after a reproducing operation or a recording operation with respect to an optical disc is over, the stop state is detected by stop-state detecting means, which then makes the optical disc rotate at a low speed. A predetermined time after the detection of the stop state, an automatic power-off function makes the optical disc stop rotating and turns power off. With this configuration, even in a stop state after a reproducing operation or a recording operation with respect to the optical disc, the rotation of the optical disc permits air inside the apparatus to circulate to cool down the inside of the apparatus, so that heat generating components are air-cooled. This helps reduce the temperature rise in the stop state and thereby eliminates adverse effects on the operating life and the recording/reproducing precision of the optical disc apparatus.

This application is based on Japanese Patent Application No. 2005-151108 filed on May 24, 2005, the contents of which are hereby incorporated by reference.

### BACKGROUND OF THE INVENTION

1. Field of the Invention

The present invention relates to an optical disc apparatus that reproduces information from an optical disc or that reproduces and records information from and to an optical disc.

2. Description of Related Art

Recently, DVDs (digital versatile discs), which are optical discs on which vast quantities of information such as video and audio data as of movies can be recorded, have been becoming widely used. Examples of currently known types of DVDs are: DVD-ROM type DVDs, on which information is pre-recorded by a manufacturer and on which a user cannot rewrite; DVD-R type DVDs, on which a user can record information only once; and DVD-RW (DVD-RAM) type DVDs, on which a user can rewrite. Information recorded on these DVDs can be reproduced on a DVD player or a DVD recorder, and information can be recorded on DVD-R type and DVD-RW (DVD-RAM) type DVDs on a DVD recorder.

In optical disc apparatuses such as DVD players, DVD recorders, and the like, attempts have been made to make them thinner and more compact. Furthermore, to meet demands for increasingly high performance and increasingly fast processing, more and more circuit elements have come to be used to build their drive control system, signal processing system, etc. These circuit elements dissipate heat, and as the drive mechanism operates increasingly fast, the rise in the temperature inside the apparatuses has been becoming unacceptably large.

The recording speeds of recent optical discs have been remarkably increasing, and the rise in the temperature inside optical disc apparatuses is accordingly large. Recording of information on an optical disc is realized by irradiating the optical disc with laser light in pulse form. To achieve stable high-speed recording on an optical disc, the higher the recording speed, the higher the recording power of the laser diode needs to be made, which leads to a rise in the temperature of the laser diode.

As described above, higher-speed recording causes a rise in the temperature of a laser diode, a rise in the temperature of a drive motor, and a rise in the temperature of each high-speed-processing LSI, resulting in an ever increasing rise in the temperature inside an optical disc apparatus. This rise in temperature has adverse effects on the operating life and the recording/reproducing precision of an optical disc apparatus.

The conventional art described in JP-A-2003-257022 makes use of face deflection and eccentricity of an optical disc, and pays attention to the fact that the turning of an optical disc generates air flows inside and outside an apparatus. In a case where the temperature around an optical pickup exceeds a predetermined value, a laser diode (a semiconductor laser) is made to suspend its light emitting operation, and the optical disc is made to rotate at a higher speed so as to cool down the inside of the apparatus. The conventional art described in JP-A-2003-77133 cools down the inside of the apparatus by rotating an optical disc at a speed according to the temperature inside the apparatus.

These conventional arts, however, are related to cooling down the inside of an apparatus during a recording operation or a reproducing operation, and after a recording operation or a reproducing operation is finished and the apparatus is in the stop state, no cooling down of the inside of the apparatus is carried out. If the inside of the apparatus is not cooled down after a recording operation or a reproducing operation and the apparatus is in the stop state, the temperature of the air inside the apparatus remains high, and in addition, components that keep operating even in the stop state of the apparatus, for example, IC components such as a power supply circuit, a memory, a video output circuit, an audio output circuit, and a control circuit, become hotter and hotter, and this disadvantageously has adverse effects on the operating life and the recording/reproducing precision of the optical disc apparatus.

In general, in a conventional optical disc apparatus, a stop state and an operating state such as a recording or reproducing state are not distinguished in the designing of a countermeasure against a rise in temperature, for example by adopting countermeasures like giving large heat dissipation lands to components and arranging heat generating components in a not densely but sparsely spaced manner. Nevertheless, if the inside of the apparatus is not cooled down when, after a recording or a reproducing operation, the apparatus is in the stop state, the temperature of the air inside the apparatus remains high, and thus the temperature of the heat generating components continues to rise, and this also disadvantageously has adverse effects on the operating life and the recording/reproducing precision of the optical disc apparatus.

### SUMMARY OF THE INVENTION

The present invention has been made to solve the problems described above, and an object of the present invention is to provide an optical disc apparatus capable of cooling down the inside therof even in a stop state after a recording operation or a reproducing operation.

To achieve the above object, according to an aspect of the present invention, an optical disc apparatus is provided with a system controller that controls such that: when the system controller detects a stop state after a reproducing operation or a recording operation with respect to an optical disc, the system controller makes the optical disc rotate at a low speed; and a predetermined time thereafter, the system controller, by using an automatic power-off function, makes the optical disc stop rotating and turns the power off.

In this configuration, in the stop state after a reproducing operation or a recording operation with respect to the optical disc, the optical disc is made to rotate at a low speed, and the predetermined time thereafter, the automatic power-off function makes the optical disc stop rotating and turns the power off.

With this configuration, even in the stop state after a reproducing operation or a recording operation with respect to the optical disc, the rotation of the optical disc permits the air inside the apparatus to circulate so as to cool down the inside of the apparatus, so that the heat generating components thereof are air-cooled, leading to a reduced rise in temperature in the stop state. This eliminates adverse effects on the operating life of the optical disc apparatus or on the recording/reproduction precision thereof, and this makes it possible to provide an optical disc apparatus having an improved quality. The optical disc rotates at a low speed in the stop state, and this helps alleviate the shortening of the operating life of a spindle motor.

In the optical disc apparatus configured as described above, the system controller is provided with: stop-state detecting means that detects the stop state after a recording operation or a reproducing operation with respect to the optical disc; stop-state disc rotating means that rotates the optical disc at a low speed when the stop state is detected; an automatic power-off function that, the predetermined time after the detection of the stop state, makes the optical disc stop rotating and turns the power off.

With this configuration, even in the stop state after a recording operation or a reproducing operation, it is possible to keep the optical disc rotating. It is also possible to make the optical disc stop rotating the predetermined time thereafter.

According to another aspect of the present invention, an optical disc apparatus is provided with a system controller that controls such that: when the system controller detects a stop state after a reproducing operation or a recording operation with respect to an optical disc, the system controller makes the optical disc rotate at a low speed; and when a timer has counted a predetermined time thereafter, the system controller makes the optical disc stop rotating and turns the power off.

In this configuration, in the stop state after a reproducing operation or a recording operation with respect to the optical disc, the optical disc is made to rotate at a low speed, and when the timer has counted the predetermined time thereafter, the optical disc is made to stop rotating, and the power is turned off.

With this configuration, even in the stop state after a reproducing operation or a recording operation with respect to the optical disc, the rotation of the optical disc permits the air inside the apparatus to circulate so as to cool down the inside of the apparatus, so that heat generating components thereof are air-cooled, leading to a reduced rise in temperature in the stop state. This eliminates adverse effects on the operating life of the optical disc apparatus or on the recording/reproduction precision thereof, and this makes it possible to provide an optical disc apparatus having an improved quality. The optical disc rotates at a low speed in the stop state, and this helps alleviate the shortening of the operating life of a spindle motor.

In the above configured optical disc apparatus, the system controller is provided with: stop-state detecting means that detects the stop state after a recording or a reproducing operation with respect to the optical disc; a timer that counts time that has passed after the detection of the stop state; stop-state disc rotating means that makes the optical disc rotate at a low speed when the stop state is detected; and disc rotation stopping/power-cutting means that, on receiving from the timer a time-out signal indicating that the predetermined time has passed after the detection of the stop state, makes the optical disc stop rotating and turns the power off.

With this configuration, even in the stop state after a recording operation or a reproducing operation, it is possible to keep the optical disc rotating. It is also possible to make the optical disc stop rotating after the predetermined time.

As described above, according to one aspect of the present invention, an optical disc is provided with a system controller that controls such that: when a stop state after a reproducing operation or a recording operation with respect to an optical disc is detected, the system controller makes the optical disc rotate at a low speed; and a predetermined time thereafter, the system controller, by using an automatic power-off function, makes the optical disc stop rotating and turns the power off. Thus, even in a stop state after a reproducing operation or a recording operation with respect to the optical disc, it is possible to cool down the inside of the apparatus by rotating the optical disc so as to circulate the air inside the apparatus. This helps air-cool the heat generating components and reduce a rise in temperature in the stop state. This eliminates adverse effects on the operating life of the optical disc apparatus or on the recording/reproduction precision thereof, and this makes it possible to provide an optical disc apparatus having an improved quality. The optical disc rotates at a low speed in the stop state, and this helps alleviate the shortening of the operating life of a spindle motor.

According to another aspect of the present invention, an optical disc apparatus is provided with a system controller that controls such that: when the stop state is detected after a recording operation or a reproducing operation with respect to an optical disc, the system controller makes the optical disc rotate at a low speed; and when the timer has counted a predetermined time thereafter, the system controller makes the optical disc stop rotating and turns the power off. Thus, even in a stop state after a reproducing operation or a recording operation with respect to the optical disc, it is possible to cool down the inside of the apparatus by rotating the optical disc so as to circulate the air inside the apparatus. This helps air-cool the heat generating components and reduce a rise in temperature in the stop state. This eliminates adverse effects on the operating life of the optical disc apparatus or on the recording/reproduction precision thereof, and this makes it possible to provide an optical disc apparatus having an improved quality. The optical disc rotates at a low speed in the stop state, and this helps alleviate the shortening of the operating life of a spindle motor.

### BRIEF DESCRIPTION OF THE DRAWINGS

FIG. 1 is a block diagram showing the configuration of a DVD recorder as an optical disc apparatus embodying the present invention;

FIG. 2 is a flow chart illustrating the operations relating to the cooling that characterizes an embodiment of the present invention; and

FIG. 3 is a flow chart illustrating the operations relating to the cooling that characterizes another embodiment of the present invention.

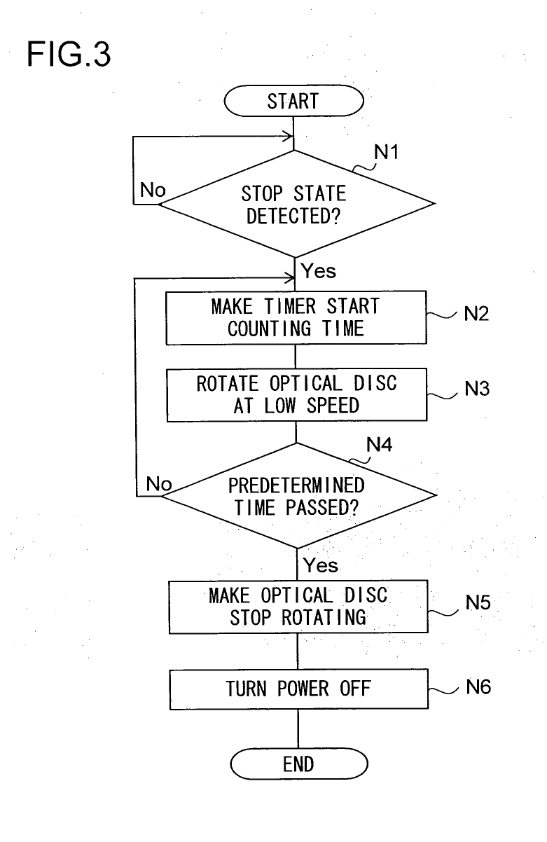

### DETAILED DESCRIPTION OF PREFERRED EMBODIMENTS

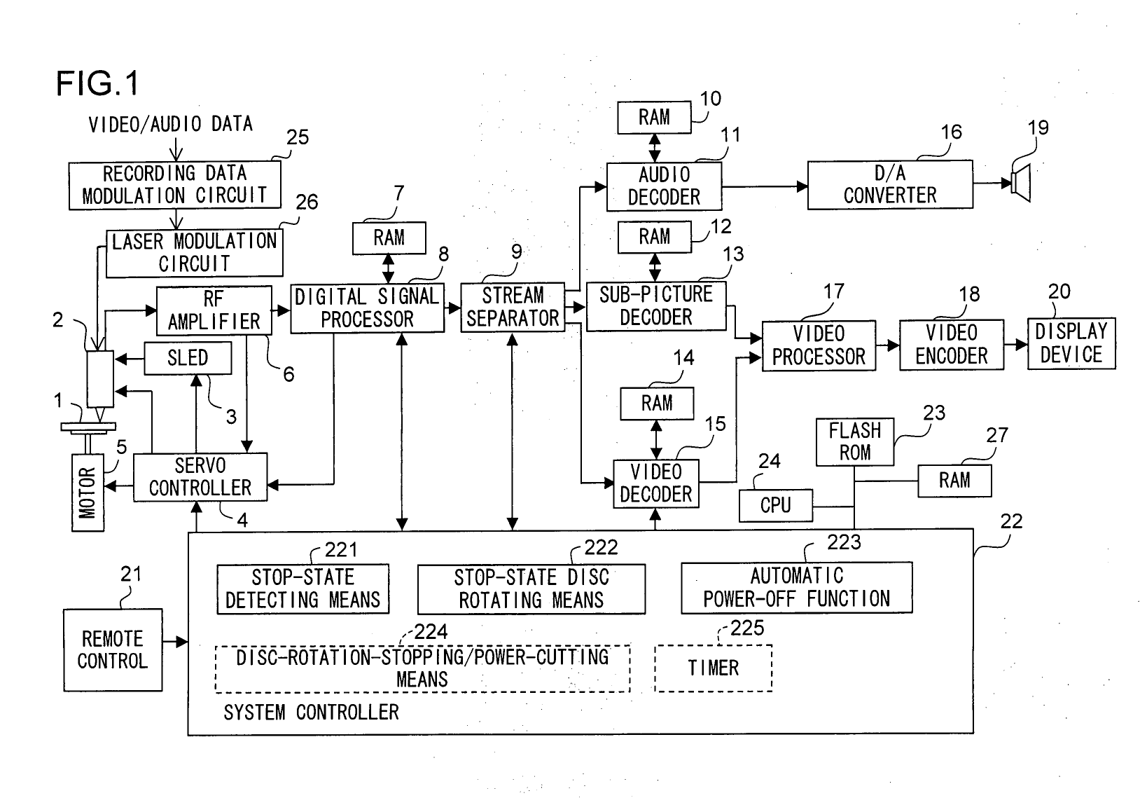

Hereinafter, embodiments of the present invention will be described with reference to the accompanying drawings. FIG. 1 is a block diagram showing the configuration of a DVD recorder as an optical disc apparatus embodying the present invention.

The DVD recorder is provided with: a spindle motor 5 that rotates an optical disc 1 a single time; an optical pickup 2 that emits laser light for performing recording/reproducing of information to/from the optical disc 1 and that receives the light reflected from the optical disc 1; a sled 3 that moves the optical pickup 2 in a radial direction of the optical disc 1; a system controller 22 that controls the whole apparatus; and a servo controller 4 that drives the spindle motor 5 and the sled 3 according to commands from the system controller 22 and that moves an objective lens (not shown) incorporated in the optical pickup 2 to control such that the focal position of the laser light is moved in directions perpendicular and parallel to a recording surface of the optical disc 1.

The DVD recorder is further provided with: an RF amplifier 6 that, when the optical disc 1 is reproduced, amplifies an RF signal which is a signal read from the optical pickup 2; a digital signal processor 8 that modulates the RF signal outputted from the RF amplifier 6 and then performs a signal demodulation and ECC error correction according to the data format of the optical disc 1 and then stores the resulting data in a RAM 7; and a stream separator 9 that, according to commands from the system controller 22, separates, from the data stream outputted from the digital signal processor 8, audio data, sub-picture data, and video data.

The DVD recorder is further provided with: an audio decoder 11 to which is inputted the audio data outputted from the stream separator 9 and that performs predetermined decoding thereon; a RAM 10 for temporarily storing data so as to permit the audio decoder 11 to perform its decoding; a sub-picture decoder 13 to which is inputted the sub-picture data outputted from the stream separator 9 and that performs predetermined decoding thereon; a RAM 12 for temporarily storing data so as to permit the sub-picture decoder 13 to perform its decoding; a video decoder 15 to which is inputted the video data outputted from the stream separator 9 and that performs predetermined decoding thereon; and a RAM 14 for temporarily storing data so as to permit the video decoder 15 to perform its decoding.

The DVD recorder is further provided with: a video processor 17 that synthesizes the data outputted from the video decoder 15 and the data outputted from the sub-picture decoder 13, both outputted according to commands from the system controller 22; a video encoder 18 that converts the synthesized data outputted from this video processor 17 into a video signal for display to make a display device 20 display an image; a D/A converter 16 that converts the data outputted from the audio decoder 11 into an analogue audio signal to feed the resulting analogue audio signal to a speaker 19 or the like.

The DVD recorder is further provided with: a remote control 21 having various operation keys for giving commands in the form of infrared signal to the system controller 22, for example, a play key for giving a command to start reproduction, a stop key for giving a command to stop reproduction, a record key for giving a command to start recording, a power key, and the like; a flash ROM 23 that stores programs and data for controlling the individual components of the apparatus and the apparatus as a whole; a CPU 24 that performs computation according to the programs and data stored in the flash ROM 23 to control the system controller 22; and a RAM 27 for temporarily storing data that is necessary for computation performed by the CPU 24.

The DVD recorder is further provided with: a recording data modulation circuit 25 for modulating the video/audio data transmitted from a television set or a personal computer (not shown) such that the resulting data can be recorded on the optical disc 1; and a laser modulating circuit 26 that feeds to the optical pickup 2 a laser modulating signal for modulating laser light that the optical pickup 2 emits based on the data modulated by the recording data modulation circuit 25.

The system controller 22 is provided with, as components that characterize an embodiment of the present invention: stop-state detecting means 221 that detects the stop state after a recording operation or a reproducing operation with respect to the optical disc 1; stop-state disc rotating means 222 that rotates the optical disc 1 at a low speed when the stop state is detected; an automatic power-off function 223 that, a predetermined time after the detection of the stop state, makes the optical disc 1 stop rotating and turns the power off.

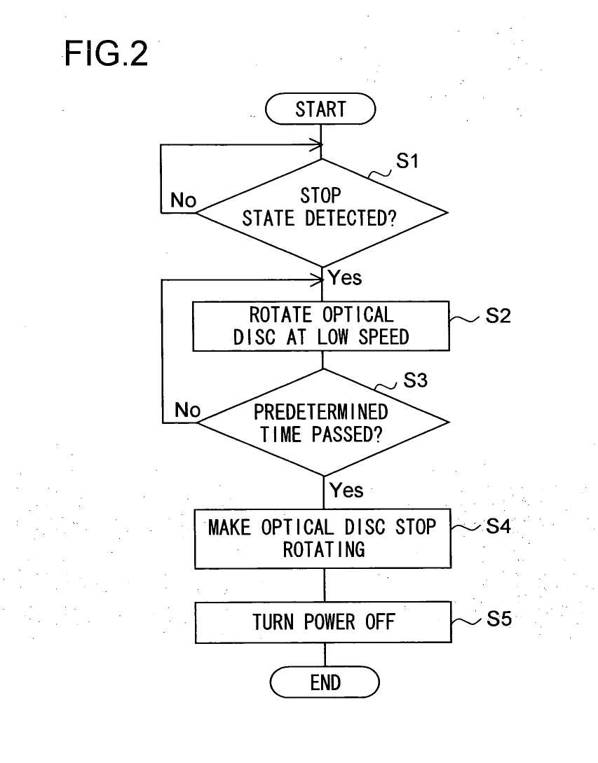

FIG. 2 is a flow chart showing the operations relating to the cooling that characterizes this embodiment of the present invention. These operations relating to cooling will be described with reference to this flow chart and FIG. 1.

First, when the optical disc 1 is loaded, and then the play key on the remote control 21 (or the play key on the optical disc apparatus) is pressed, the system controller, in response to the command to start reproduction, sets the apparatus in the play mode. In the play mode, the spindle motor 5 rotates to cause the optical disc 1 to rotate, and meanwhile the optical pickup 2 reads recorded information from the optical disc 1. The information read by the optical pickup 2 is then fed to the RF amplifier 6, the digital signal processor 8, the stream separator 9, the audio decoder 11, and the D/A converter 16 (how these operate has been described above), and in this way, an audio signal is reproduced, and is then converted into sound by a speaker 19. On the other hand, the information read by the optical pickup 2 is fed to the RF amplifier 6, the digital signal processor 8, the stream separator 9, the sub-picture decoder 15, the video processor 17, and the video encoder 18, and in this way, a video signal is reproduced, and is then converted into video by a display device 20.

Here, when the reproduction of information with respect to the optical disc 1 is completed and the apparatus is in the stop state, or when the stop key on the remote control 21 (or the stop key on the apparatus) is pressed to cause the apparatus to be in the stop state, the stop state is detected by the stop-state detecting means 221 of the system controller 22 (Step S1). At this time, the stop-state disc rotating means 222 of the system controller 22 rotates the spindle motor 5 at a low speed through the servo controller 4, and thereby rotates the optical disc 1 at a low speed (Step S2).

A predetermined time after the detection of the stop state (Step S3), the automatic power-off function 223 of the system controller 22 stops the spindle motor 5 through the servo controller 4, and thereby makes the optical disc 1 stop rotating (Step S4), and turns off the power to the apparatus (Step S5). The above description deals with the operations performed after a reproducing operation is stopped and the apparatus is in the stop state, but is equally applicable to the operations performed after a recording operation is stopped and the apparatus is in the stop state. The reproducing operation here includes fast forward reproduction and fast backward reproduction as well as ordinary reproduction.

According to this embodiment, even in the stop state after a reproducing operation or a recording operation with respect to an optical disc, the rotation of the optical disc permits the air inside the apparatus to circulate so as to cool down the inside of the apparatus, so that the heat generating components are air-cooled, leading to a reduced rise in temperature in the stop state. This eliminates adverse effects on the operating life of the optical disc apparatus or on the recording/reproduction precision thereof, and this makes it possible to provide an optical disc apparatus having an improved quality. The optical disc rotates at a low speed in the stop state, and this helps alleviate the shortening of the operating life of the spindle motor.

FG. 3 is a flow chart illustrating the operations relating to the cooling that characterizes another embodiment of the present invention. These operations relating to the cooling will be described with reference to this flow chart and FIG. 1.

In this embodiment, the system controller 22 is not provided with the automatic power-off function 223. The system controller 22 here is provided with: stop-state detecting means 221 that detects a stop state after a recording or a reproducing operation with respect to the optical disc is over; a timer 225 that counts the time that has passed after the detection of the stop state; stop-state disc rotating means 222 that rotates an optical disc 1 at a low speed when the stop state is detected; and disc-rotation-stopping/power-cutting means 224 that, on receiving from the timer 225 a time-out signal indicating that a predetermined time has passed after the detection of the stop state, makes the optical disc 1 stop rotating and turns the power off.

Here, when the reproduction of information with respect to the optical disc 1 is completed and the apparatus is in the stop state, or when the stop key on a remote control 21 (or the stop key on the apparatus) is pressed to cause the apparatus to be in the stop state, the stop state is detected by the stop-state detecting means 221 of the system controller 22 (Step N1). At this time, the timer 225 starts counting time (Step N2), and the stop-state disc rotating means 222 of the system controller 22 rotates a spindle motor 5 at a low speed through a servo controller 4, and thereby rotates the optical disc 1 at a low speed (Step N3).

Then, the disc-rotation-stopping/power-cutting means 224, on receiving from the timer 225 a time-out signal indicating that a predetermined time has passed after the detection of the stop state (Step N4), stops the spindle motor 5 through the servo controller 4 of the system controller 22, and thereby makes the optical disc 1 stop rotating (Step N5) and turns off the power to the apparatus (Step N6). The above description deals with the operations performed after a reproducing operation is stopped and the apparatus is in the stop state, but is equally applicable to the operations performed after a recording operation is stopped and the apparatus is in the stop state. The reproducing operation here includes fast forward reproduction and fast backward reproduction as well as ordinary reproduction.

According to these embodiments, even in the stop state after a reproducing operation or a recording operation with respect to an optical disc, the rotation of the optical disc permits the air inside the apparatus to circulate so as to cool down the inside of the apparatus, so that the heat generating components are air-cooled, and this helps reduce the rise in temperature in the stop state. This eliminates adverse effects on the operating life of the optical disc apparatus and on the recording/reproduction precision thereof, and thereby makes it possible to provide an optical disc apparatus having an improved quality. The optical disc rotates at a low speed in the stop state, and this helps alleviate the shortening of the operating life of the spindle motor 5.

The embodiments described above all deal with a DVD recorder as an optical disc apparatus. In a reproduction-only DVD player, however, by giving the system controller thereof a similar function, it is possible to circulate the air inside the apparatus by rotating an optical disc and thereby to cool down the inside of the apparatus even in a stop state after a reproducing operation.

What is claimed is:

1. An optical disc apparatus, comprising a system controller that controls such that:
when the system controller detects a stop state after a reproducing operation or a recording operation with respect to an optical disc, the system controller makes the optical disc rotate at a low speed; and
a predetermined time thereafter, the system controller, by using an automatic power-off function, makes the optical disc stop rotating and turns power off.

2. The optical disc apparatus of claim 1, wherein the system controller comprises:
stop-state detecting means that detects a stop state after a recording operation or a reproducing operation with respect to the optical disc;
stop-state disc rotating means that makes the optical disc rotate at a low speed when the stop state is detected; and
an automatic power-off function that, a predetermined time after the detection of the stop state, makes the optical disc stop rotating and turns power off.

3. An optical disc apparatus, comprising a system controller that controls such that:
when the system controller detects a stop state after a reproducing operation or a recording operation with respect to an optical disc, the system controller makes the optical disc rotate at a low speed; and
when a timer has counted a predetermined time thereafter, the system controller makes the optical disc stop rotating and turns power off.

4. The optical disc apparatus of claim 3, wherein the system controller comprises:
stop-state detecting means that detects a stop state after a recording operation or a reproducing operation with respect to the optical disc;
a timer that counts time that has passed after the detection of the stop state;
stop-state disc rotating means that makes the optical disc rotate at a low speed when the stop state is detected; and
disc-rotation-stopping/power-cutting means that, on receiving from the timer a time-out signal indicating that the predetermined time has passed after the detection of the stop state, makes the optical disc stop rotating and turns power off.
